(19) United States
(12) Patent Application Publication
(10) Pub. No.: US 2002/0138727 A1
(43) Pub. Date: Sep. 26, 2002

(54) System and process for enhancing method calls of special purpose object-oriented programming languages to have security attributes for access control

(75) Inventors: Rabindranath Dutta, Austin, TX (US); Karthikeyan Ramamoorthy, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 09/817,102

(22) Filed: Mar. 26, 2001

(51) Int. Cl. H04L 9/00

(52) U.S. Cl. 713/167

(57) ABSTRACT

A process, a system, an apparatus, and a computer program product are presented for generating and using an enforcement construct within a special purpose object-oriented programming language in order to control access to a protected method. Within source code statements, the enforcement construct comprises an enforcement keyword that indicates an authorization restriction on the invocation of an object-oriented method in conjunction with an identifier of an authorization method. In the runtime environment, when a call is initiated to an object-oriented method, a check is made as to whether the object-oriented method has been protected by an enforcement construct. If so, then the authorization method is invoked, which determines whether an entity that is attempting to call or invoke the object-oriented method is authorized to execute the object-oriented method. If so, then the object-oriented method is invoked, and if not, an error response may be returned to the calling entity.

### BACKGROUND OF THE INVENTION

1. Field of the Invention

The present invention relates to an improved data processing system and, in particular, to a methodology and system for software program implementation. Still more particularly, the present invention provides a methodology and system for a special purpose object-oriented programming language structure.

2. Description of Related Art

Maintenance of software applications within an enterprise is a laborious issue, both technically and administratively. Over any given period of time, applications are installed, updated, and removed. In addition, corporate staff turnover results in the loss of personnel that wrote and maintained applications, thereby removing institutional knowledge about the applications. The benefits of object-oriented methodologies in alleviating these types of continuity problems are well-known.

Security administration within a distributed data system is also a burdensome task. Corporate personnel require access to protected resources in a secure manner. Network interoperability also increases security risks such that the cost of mistakes in security administration can be significant. The combination of software maintenance and security tasks results in a difficult environment for information technology (IT) management.

Adding to the complexity of the issue is the fact that specific functionality within the software system may itself be a protected resource. In other words, protected resources can include not only databases and physical devices but also, depending on the design of the software architecture, a software module. For example, a first software module may request that a second software module perform a particular process that is restricted to authorized requesters. The second software model performs the restricted process only after the first software module has been authorized in some manner.

Previous solutions for implementing secure access control to a protected process, e.g., a protected method within a software module, have included an authorization module within the runtime environment that performs an authorization process upon an occurrence of an event by the requesting module. Typically, implementing access control to protected methods has involved intercepting calls to these protected methods and then dynamically consulting an access control list (ACL) to determine whether a requesting module, such as a client application, should be allowed to execute the protected method. For example, two client applications might be used by different classes of users with different authority within a system, and a protected method within a server application should be allowed to be executed by the first application but not by the second application. One type of prior art solution constructed a filter application through which requests to the server application passed. When either the first or the second application called the protected method, the filter application would intercept the call and ensure the proper access control among the requesting applications. Generally, this type of solution is quite complex as specialized code needs to be written for the filter application.

Therefore, it would be advantageous to use the benefits of object-oriented methodologies to simplify the manner in which access control is implemented for a protected method. It would be particularly advantageous to use structures incorporated into special purpose object-oriented programming languages in order to control access to protected methods.

### SUMMARY OF THE INVENTION

A process, a system, an apparatus, and a computer program product are presented for generating and using an enforcement construct within a special purpose object-oriented programming language in order to control access to a protected method. Within source code statements, the enforcement construct comprises an enforcement keyword that indicates an authorization restriction on the invocation of an object-oriented method in conjunction with an identifier of an authorization mechanism, such as an authorization method. In the runtime environment, when a call is initiated to an object-oriented method, a check is made as to whether the object-oriented method has been protected by an enforcement construct. If so, then the identifier of the associated authorization method is used to invoke the authorization method, which determines whether an entity that is attempting to call or invoke the object-oriented method is authorized to execute the object-oriented method. If so, then the object-oriented method is invoked, and if not, an error response may be returned to the calling entity. The enforcement construct may be applied at the class level such that each method defined within a class becomes a protected method.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A is a block diagram depicting a prior art mechanism of establishing the identity of a client;

FIG. 2B is a block diagram depicting a prior art mechanism of controlling access to a protected method through the use of an interceptor application or module;

FIG. 3 is a block diagram depicting a methodology for controlling access to a protected method using a special construct in an object-oriented programming language in accordance with a preferred embodiment of the present invention;

FIGS. 4A-4B are examples of uses of an enforcement construct in a special purpose object-oriented programming language in accordance with a preferred embodiment of the present invention;

FIG. 5 is a block diagram showing major components of a typical compiler for generating an executable module using a known process;

FIG. 6 is a diagram showing the manner in which a grammar for an object-oriented programming language may be extended to form an extended grammar for a special purpose object-oriented programming language that supports the use of the enforcement structure in accordance with a preferred embodiment of the present invention;

FIG. 7A is a table showing the reserved words that may be used by a scanner for a known object-oriented programming language;

FIG. 7B is a table showing the reserved words that may be used by a scanner that has been extended for a special purpose object-oriented programming language that supports the use of the enforcement structure in accordance with a preferred embodiment of the present invention;

FIG. 8 is a set of exemplary class definitions showing the use of an enforcement construct in a special purpose object-oriented programming language in accordance with a preferred embodiment of the present invention;

FIGS. 9A-9C are diagrams depicting identity information and a set of class descriptors within the runtime environment in accordance with a preferred embodiment of the present invention; and

FIGS. 10A-10B are flowcharts depicting processes for generating and using the enforcement construct in accordance with a preferred embodiment of the present invention.

### DETAILED DESCRIPTION OF THE INVENTION

The present invention provides a methodology and a system for using structures incorporated into special purpose object-oriented programming languages in order to control access to protected methods. As background, a typical organization of hardware and software components within a distributed data processing system is described prior to describing the present invention in more detail.

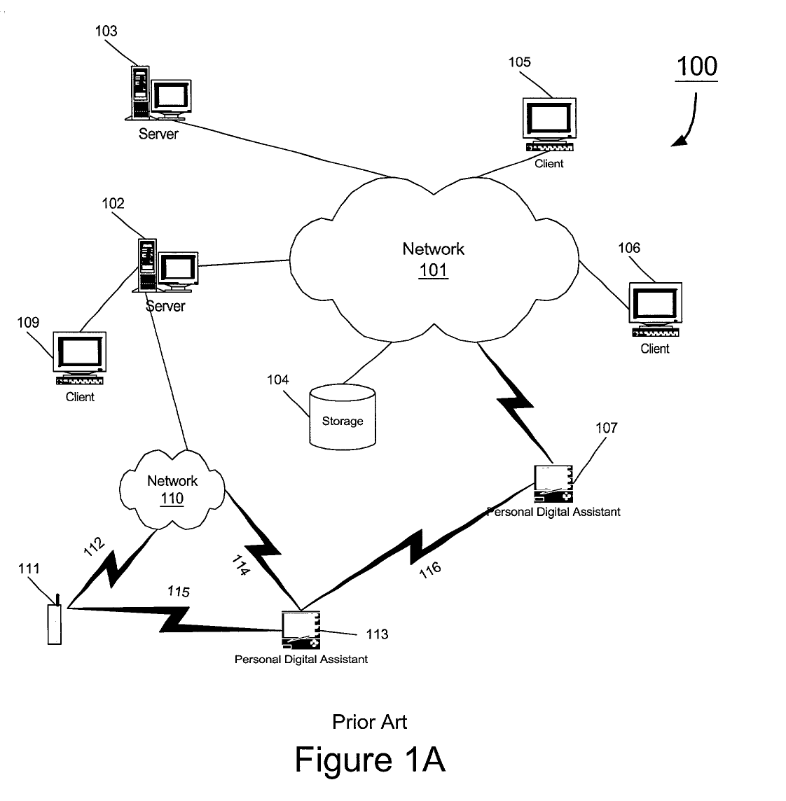

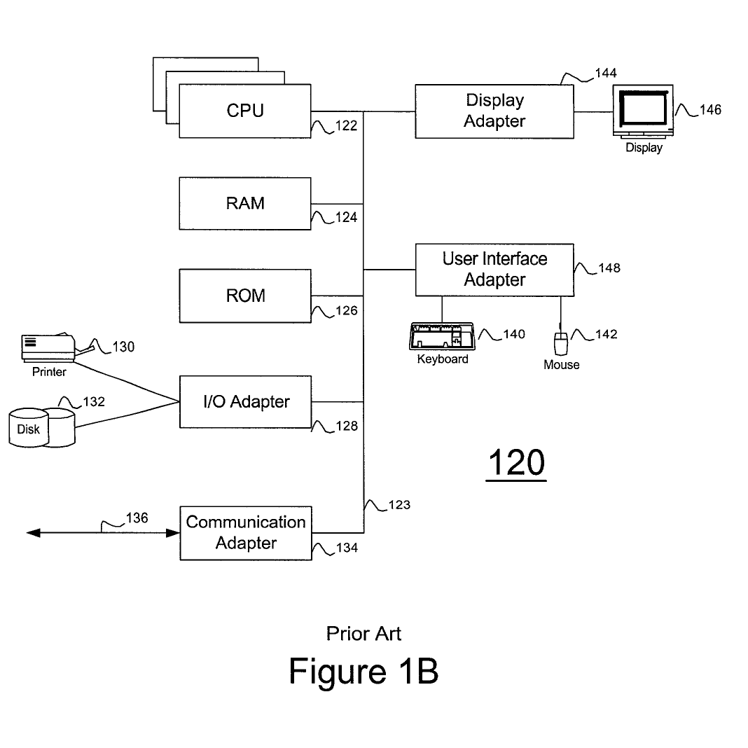

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention. It should be noted that the distributed data processing system shown in FIG. 1A is contemplated as being fully able to support a variety of peer-to-peer subnets and peer-to-peer services.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, and various other formats and types of files.

The present invention may be implemented on a variety of hardware and software platforms, as described above. More specifically, though, the present invention is directed to providing structures incorporated into special purpose object-oriented programming languages in order to control access to protected methods. As further background, however, an organization of software components within a typical authentication and authorization architecture is described prior to describing the present invention in more detail.

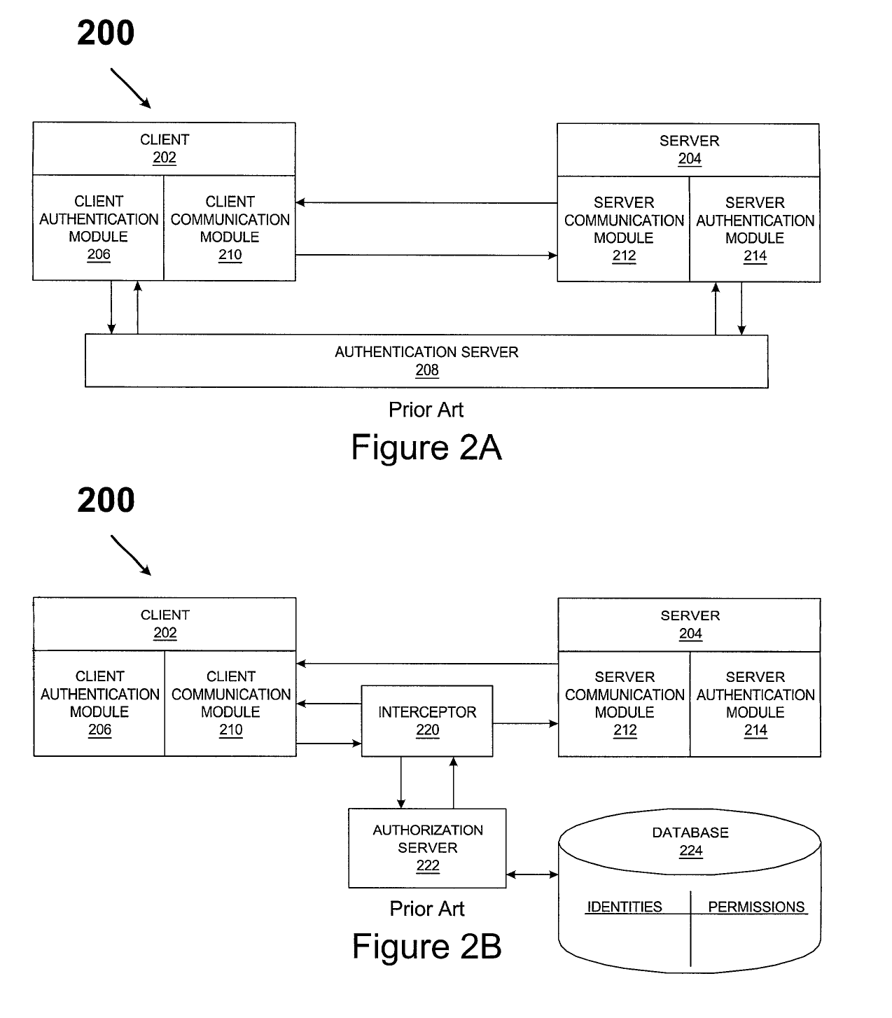

With reference now to FIG. 2A, a block diagram depicts a prior art mechanism of establishing the identity of a client. System 200 is similar to the distributed processing system shown in FIG. 1A. System 200 contains client 202 that requests access to a protected method supported on server 204; it is assumed that client 202 and server 204 are object-oriented applications or modules.

Prior to being able to access the protected method, client 202 must establish its identity in some manner. Client authentication module 206 sends a request to authentication server 208 in order to obtain an appropriate authentication token or other type of authentication credentials. For example, authentication server 208 may be a Kerberos server; Kerberos is a well-known authentication protocol. Server 208 issues an authentication token to client authentication module 206, which uses the authentication token for subsequent requests to other servers that require an authentication token prior to receiving access to a protected resource.

Client 202 then uses client communication module 210 to present its authentication token to server 204, which itself uses server communication module 212. For example, client communication module 210 and server communication module 212 may communicate in a platform-independent manner using Common Object Request Broker Architecture (CORBA) services, which allow a CORBA-based program from any vendor, on almost any computer, operating system, programming language, and network, to interoperate with a CORBA-based program from the same or another vendor, on almost any other computer, operating system, programming language, and network. Server communication module 212 passes the client's authentication token to server authentication module 214, which verifies the client's authentication token with assistance from authentication server 208. Server 204 then notifies client 202 that the client's authentication token has been verified, i.e., that the client has been authenticated.

With reference now to FIG. 2B, a block diagram depicts a prior art mechanism of controlling access to a protected method through the use of an interceptor application or module. FIG. 2B is similar to FIG. 2A; common reference numerals in the figures refer to common elements. For simplicity in presentation, authentication server 208 is not shown in FIG. 2B; interceptor 220, authorization server 222, and database 224, which were not shown in FIG. 2A, are now shown in FIG. 2B. Again, client 202 is attempting to invoke a protected method supported on server 204.

An application or module on client 202 makes a request to invoke the protected method via an appropriate mechanism. Rather than server 204 receiving the request, interceptor 220 receives the request, and interceptor 220 then attempts to verify whether the request should be granted. In other words, the interceptor determines whether the requester should be authorized to gain access to the protected method, i.e., whether the protected method can be executed on behalf of the requester.

The request for the protected method is accompanied by some type of information that identifies the requester. Interceptor 220 sends an authorization verification request to authorization server 222, which then attempts to match the identifier with information from database 224. After determining whether the identification information matches approved identification information within database 224, authorization server 222 then returns either an approval or a denial to interceptor 220. If authorization has been denied, then interceptor 220 quashes the call to the protected method by notifying client 202 in the appropriate manner, e.g., by returning an error code to the requesting module.

If authorization has been obtained, interceptor 220 then forwards the request to invoke the protected method to server 204. Since the request has some type of client identification information, and because client 202 has already performed an authentication process with server 204, server 204 is able to determine that client 202 is both authenticated and authorized to run the protected method. After the protected method is invoked, it may respond to the request as necessary, including returning information to client 202.

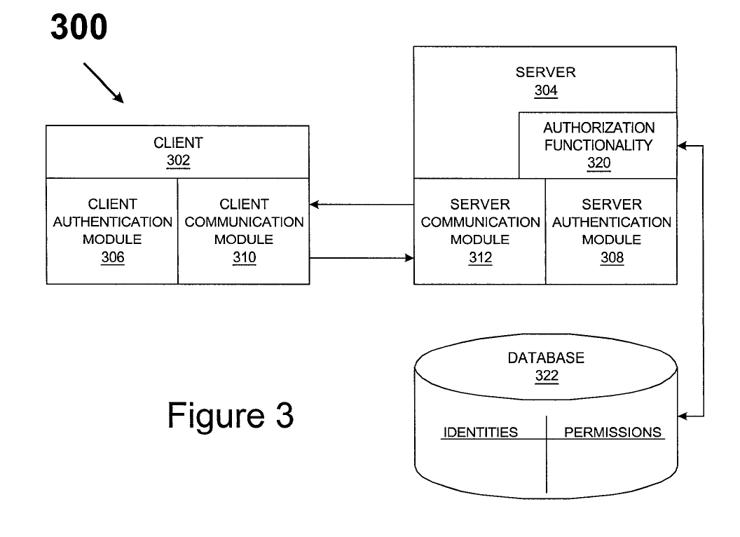

With reference now to FIG. 3, a block diagram depicts a methodology for controlling access to a protected method using a special construct in an object-oriented programming language in accordance with a preferred embodiment of the present invention. FIG. 3 is similar to FIG. 2A. System 300 requires some type of authentication mechanism, such as the authentication server shown in FIG. 2A, prior to allowing any entity to have access to the protected method. Again, for simplicity in presentation, an authentication server is not shown in FIG. 3, but the authorization components of the present invention are now shown in FIG. 3.

Again, client 302 is attempting to invoke a protected method supported on server 304; it is assumed that client 302 and server 304 are object-oriented applications or modules. In a manner similar to that shown in FIG. 2A, client 202 must establish its identity in some manner and uses authentication module 306 to do so while server 304 uses authentication module 308 for verification purposes. Client 302 uses client communication module 310 to communicate with server communication module 312 of server 304 in a manner similar to that described above for FIG. 2A.

At some point in time, an application or module on client 302 makes a request to invoke the protected method via an appropriate mechanism. In the present invention, server 304 directly receives the invocation request. Object-oriented authorization functionality 320 within server 304 then attempts to determine, with reference to database 322, whether the client identification information associated with the invocation request matches any authorized entities. In response to a negative determination, object-oriented authorization functionality 320 quashes the call to the protected method by notifying client 302 in the appropriate manner, e.g., by returning an error code to the requesting module.

In response to a positive authorization result, server 304 is able to determine that client 302 is both authenticated and authorized to run the protected method because client 302 has already performed an authentication process with server 304. Hence, the protected method is invoked, after which it may respond to the request as necessary, including returning information to client 302.

It should be noted that the client identification information may identify an authorized user. However, more broadly, the authorization process may authorize entities or principals that include authorized applications or authorized devices, each of which might operate in some type of privileged mode. It should also be noted that the authorization process may involve many different types of authorization models or mechanisms. For example, the authorization process may use an access control list (ACL) authorization model or a role-based access control (RBAC) authorization model.

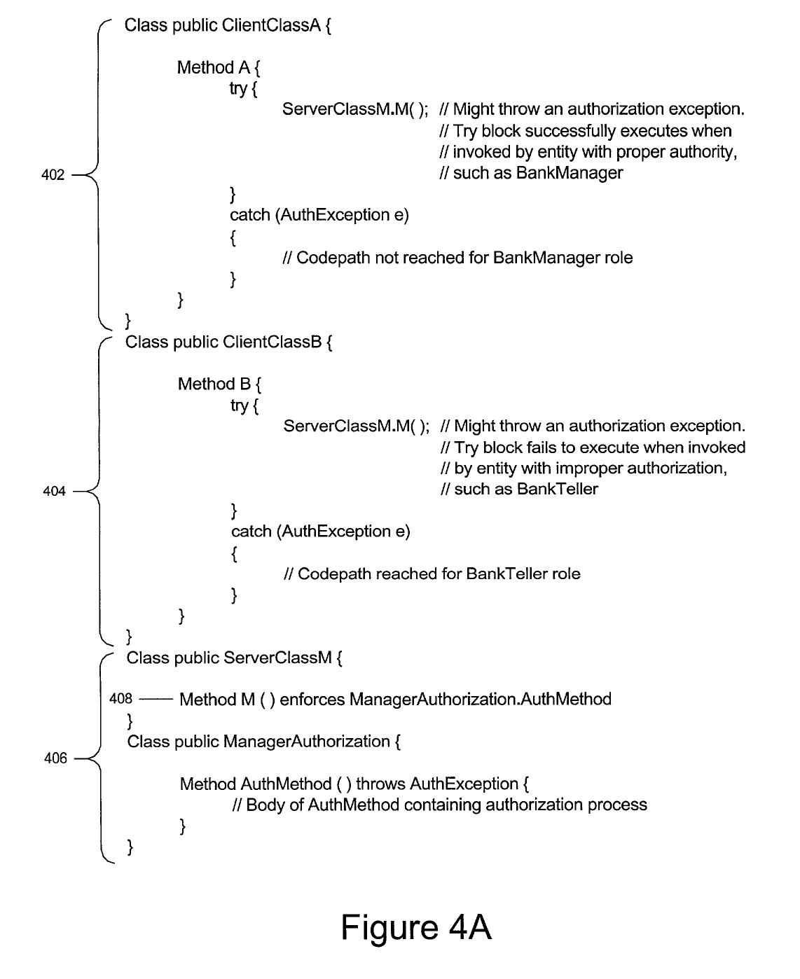

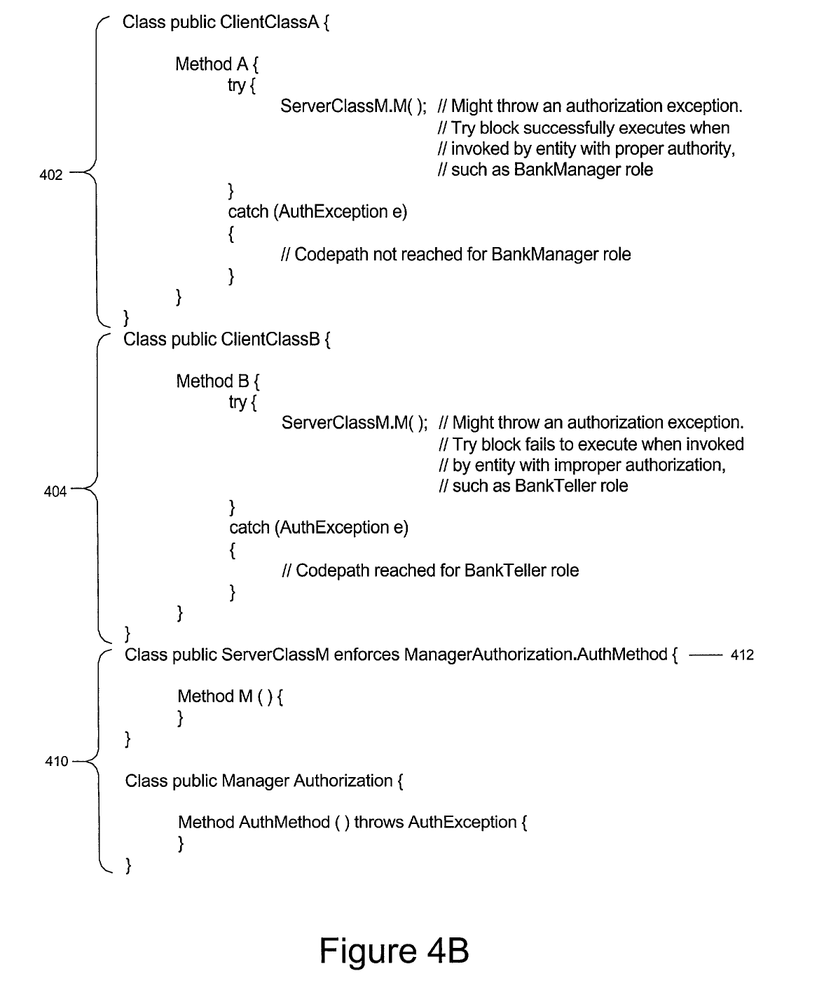

With reference now to FIGS. 4A-4B, examples are provided of uses of an enforcement construct in a special purpose object-oriented programming language in accordance with a preferred embodiment of the present invention. Code portion 402 is an example of a portion of object-oriented source code, i.e., program statements for an application using an object-oriented programming language, that might be used within a first client application or client module, whereas code portion 404 is an example of a portion of object-oriented source code that might be used within a second client application or client module.

One benefit of the modular nature of object-oriented programming is that code portions or modules may be reused within different applications without modification or possibly with minor modification. Hence, code portions 402 and 404 are very similar in structure: code portion 402 defines a class “ClientClassA” that contains method “A” that invokes method “M” in class “ServerClassM”; code portion 404 defines a class “ClientClassB” that contains method “B” that invokes method “M” in class “ServerClassM”. Code portions 402 and 404 may be otherwise identical, or there may be slight differences between the code portions in other programming language statements that are not shown.

However, there is an operational difference between code portion 402 and code portion 404 that would arise during runtime execution of the compiled code because class “ClientClassA” has been compiled into a first application module while class “ClientClassB” has been compiled into a second application or module. Assume that the first application is being used by a user with a first authority role, such as a bank manager, while the second application is being used by a user with a second authority role, such as a bank teller. When the bank manager started using the first application, it performed a logon authentication process upon the identification information provided by the bank manager, and when the bank teller started using the second application, it performed a logon authentication process upon the identification information provided by the bank teller. At some point in time, the bank manager requests some type of action that causes the execution of method “A” within class “ClientClassA”; likewise, at some point in time, the bank teller requests some type of action that causes the execution of method “B” within class “ClientClassB”. Both method “A” and method “B” will attempt to invoke method “M” of class “ServerClassM”.

When method “M” of class “ServerClassM” is invoked, an exception might be thrown, as shown in code portion 406, which depicts a portion of object-oriented source code that might be used for the server-side functionality. Code portion 406 defines the public class “ServerClassM” that defines method “M”. Statement 408 within code portion 406 shows that execution of the method “M” may result in an exception being thrown, as discussed in more detail below; the throwing of an exception is a well-known error-reporting mechanism in object-oriented languages. However, statement 408 also shows the novel enforcement construct within an object-oriented programming language in accordance with a preferred embodiment of the present invention.

The “enforces” keyword shown within statement 408 causes code portion 406 to be compiled in a manner such that authorization functionality is generated for the server module that includes it. The authorization functionality, such as authorization functionality 320 shown in FIG. 3, performs an authorization process upon the requester. Identification information for the requester is obtained from the server runtime environment, and the method that is being protected is or is not invoked depending upon the result of the authorization process.

In summary, the enforcement construct of the present invention comprises an enforcement keyword within a special purpose object-oriented programming language that qualifies the invocation of an object-oriented method in conjunction with an identifier of an authorization mechanism to be invoked to perform the authorization process.

Referring again to the example in FIG. 4A, when method “A” and method “B” attempt to invoke method “M” of class “ServerClassM”, it is not possible to predict whether protected method “M” will execute without reference to the state of the runtime environment. The request to invoke method “M” of class “ServerClassM” might result in the throwing of an exception, depending upon the result of the authorization mechanism, which relies upon predetermined authorization information. In this example, method “M” is protected by enforcing an authorization process defined by method “AuthMethod” of class “ManagerAuthorization”. Hence, the invocation of method “M” within method “A” will successfully execute because method “M” was invoked on behalf of a user who has been authenticated as being a particular user and whose identification information matches one of a set of authorized users, i.e., bank managers, as determined by the “ManagerAuthorization” mechanism. The invocation of method “M” within method “B” will not cause the execution of method “M” because method “M” was invoked on behalf of a user who has been authenticated as being a particular user but whose identification information, i.e., as a bank teller, does not match one of a set of authorized users, i.e., bank managers, as determined by method “AuthMethod” of class “ManagerAuthorization”. Moreover, as coded in FIG. 4A, the failure of the authorization process in method “AuthMethod” throws an exception, which is eventually caught by method “B” in code portion 404, which may then execute some type of error procedure in an appropriate manner.

The description of FIG. 4B follows in a very straightforward manner from the description of FIG. 4A; similar reference numerals represent similar elements. Referring to FIG. 4B, code portion 410 shows that the enforcement construct has been used within programming language statement 412 in the definition of class “ServerClassM”. In the example in FIG. 4B, the enforcement construct enforces an authorization construct, similar to that described above with respect to FIG. 4A, except that the enforcement is performed at the class level such that no methods that are defined within the enforced class are executed if the authorization mechanism fails; all methods in the class are protected methods. In other words, all of the methods within the class are protected by the authorization mechanism.

As shown in the operational example provided above in FIG. 3 and FIGS. 4A-4B, the present invention enhances an object-oriented programming language by including an enforcement construct within a special purpose object-oriented programming language. After writing source code for a software module that uses the enforcement construct, the source code is compiled in a manner such that an executable object code module corresponding to the source code performs an authorization process as necessary. The following figures provide more detail for generating an executable module that includes object-oriented authorization functionality in accordance with a preferred embodiment of the present invention.

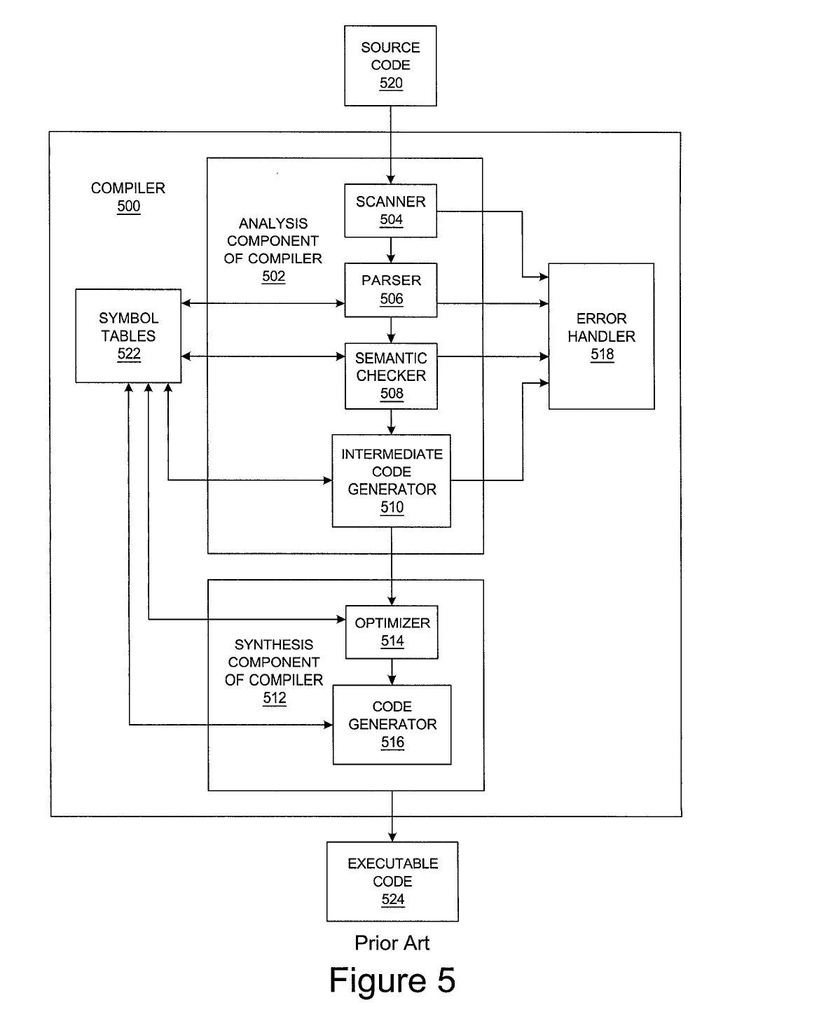

With reference now to FIG. 5, a block diagram shows major components of a typical compiler for generating an executable module using a known process. Compiler 500 comprises analysis component 502, which itself comprises scanner 504, parser 506, semantic checker 508, and intermediate code generator 510. Compiler 500 also comprises synthesis component 512, which itself comprises optimizer 514 and code generator 516. In addition, the components of the analysis component may use error handler 518 to handle errors generated by the subcomponents of the analysis component.

Scanner 504 reads one or more source code files 520 to obtain programming language statements; the statements are then lexically analyzed to generate various types of tokens, such as reserved-word tokens, end-of-line tokens, parenthetical-expression tokens, etc. Scanner 504 passes the tokens to parser 506, which analyzes a set of tokens for programmatic structures. Semantic checker 508 verifies the parsed information against a language grammar, and if the program is semantically correct, intermediate code generator 510 stores an intermediate form of code. Parser 506 and semantic checker 508 use symbol tables 522 to store and retrieve symbols that have been used within the source code to represent variable names, function names, etc., along with information about the positions of the symbols within various programmatic structures.

Optimizer 514 within the synthesis component of the compiler may then analyze the intermediate code with reference to the symbol tables to look for various ways to organize processing paths through the code such that well-known execution bottlenecks can be avoided during runtime execution of the code. Optimizer 514 may move certain programmatic structures in relation to other structures, in which case the symbol table information may need to be updated. Code generator 516 then generates executable code 524. Other well-known steps, such as using a linker to link together multiple executable modules, have not been shown. Executable code 524 may be native object code, interpretable bytecodes, etc., as necessary for deployment within a given system.

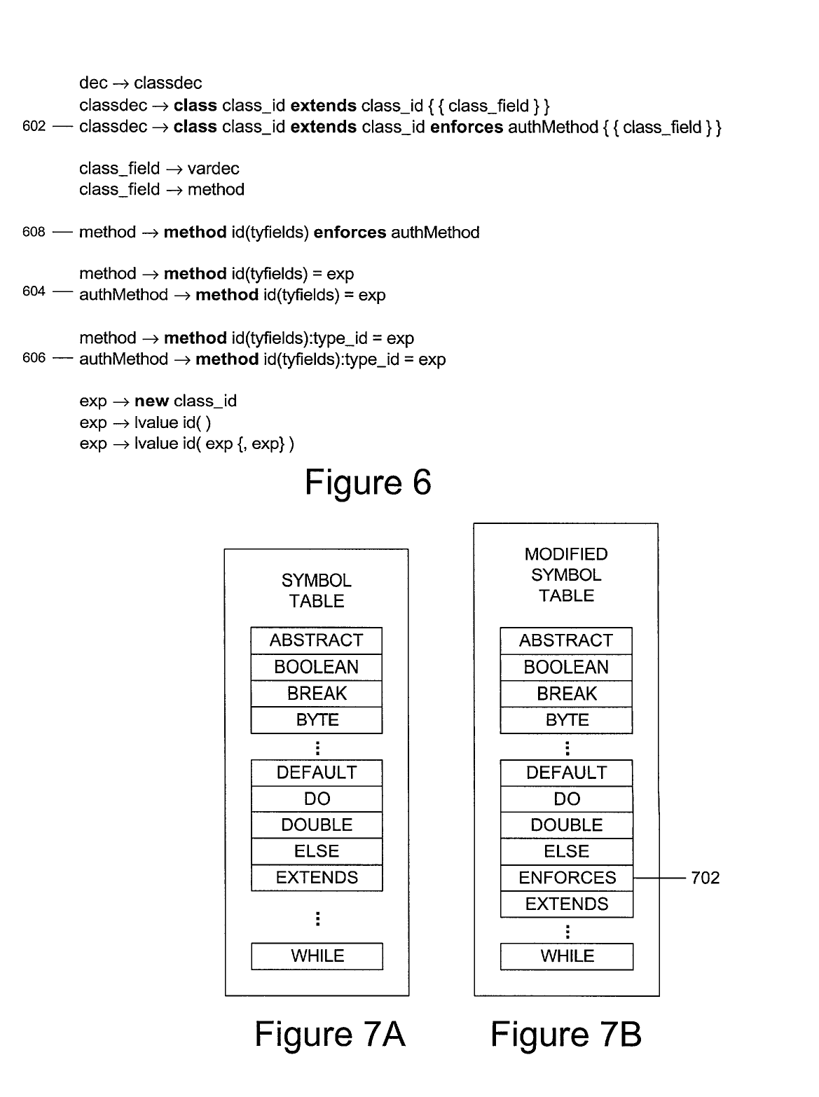

With reference now to FIG. 6, a diagram shows the manner in which a grammar for an object-oriented programming language may be extended to form an extended grammar for a special purpose object-oriented programming language that supports the use of the enforcement structure in accordance with a preferred embodiment of the present invention. FIG. 6 shows some, but not all, of the individual grammar rules that may be used by a compiler when compiling source code statements that have been written in a special purpose object-oriented programming language that supports the use of the enforcement structure. The grammar specified within FIG. 6 is for an object-oriented version of the language “Tiger” as described in Appel, Modern Compiler Implementation in Java, Cambridge University Press, January 1998. It should be noted, however, that the present invention may be implemented in a variety of object-oriented programming languages with appropriate extensions to the corresponding grammar as necessary.

Rules 602-608 are some of the new rules that would be added to the grammar of an existing object-oriented programming language in order to extend it to form an extended grammar for a special purpose object-oriented programming language that supports the use of the enforcement structure. Rule 602 represents a class declaration form that may be used to declare a class that extends another class with optional use of an enforcement structure, which comprises the use of the “enforces” keyword in conjunction with an authorization mechanism identified by “AuthMethod”; in the preferred embodiment, the authorization mechanism identifier is a method identifier. Rules 604 and 606 represents two different authorization method declaration forms that may be used to declare an authorization method. Rule 608 represents a method declaration form that may be used to declare a method with optional use of an enforcement structure which comprises the use of the “enforces” keyword in conjunction with an authorization mechanism identified by “AuthMethod”; in the preferred embodiment, the authorization mechanism identifier is a method identifier.

With reference now to FIG. 7A, a table shows the reserved words that may be used by a scanner for a known object-oriented programming language. A scanner, such as scanner 504 in FIG. 5, uses a table of reserved words to determine whether a scanned word has lexical significance within a programming language.

With reference now to FIG. 7B, a table shows the reserved words that may be used by a scanner that has been extended for a special purpose object-oriented programming language that supports the use of the enforcement structure in accordance with a preferred embodiment of the present invention. Reserved word 702, shown as “enforces” within the example, has been added to the scanner's table of reserved words so that it may identify the use of “enforces” within a source code file.

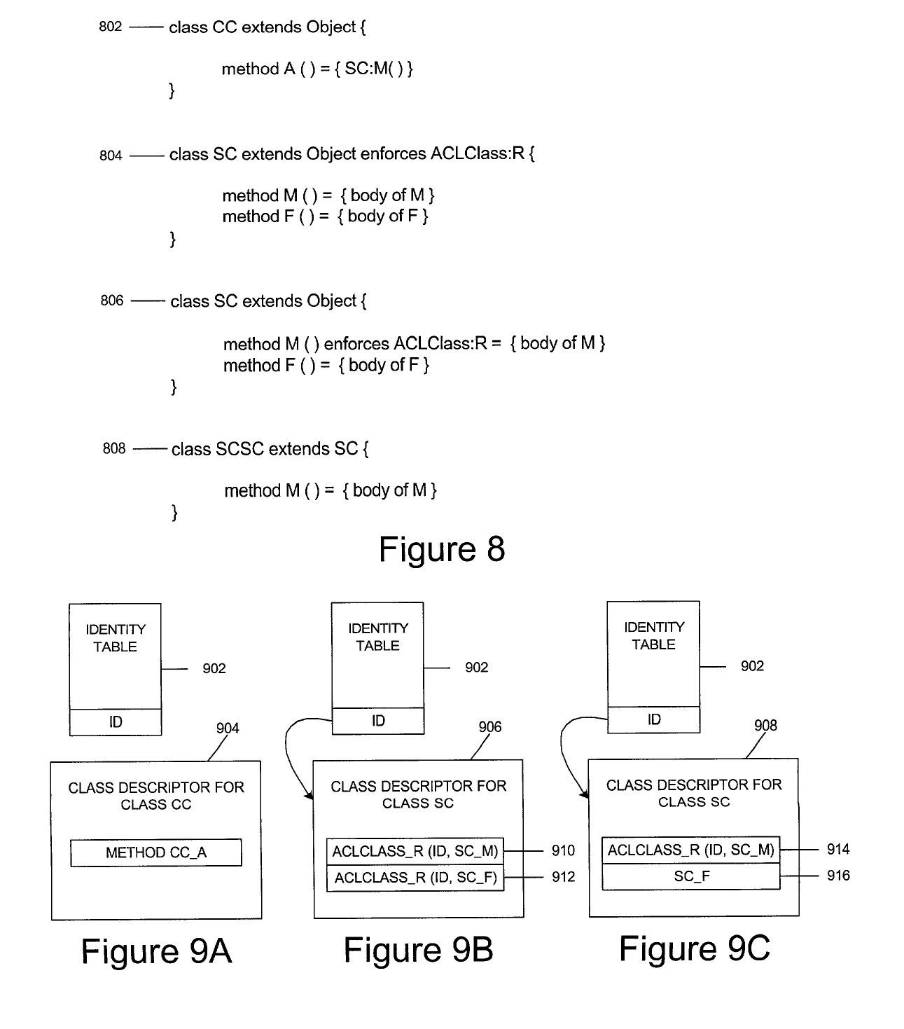

With reference now to FIG. 8, a set of exemplary class definitions show the use of an enforcement construct in a special purpose object-oriented programming language in accordance with a preferred embodiment of the present invention. While FIG. 8 is similar to FIG. 4, FIG. 8 shows class definitions in a manner that is consistent with the extended grammar shown in FIG. 6. As noted previously, the present invention supports a variety of authorization mechanisms; FIG. 8 depicts an example that uses an ACL model.

Class definition 802 is a class definition for a class “CC” in a client-side application or module; class “CC” contains a method “A” that calls method “M” of class “SC”, which is a class within a server-side application or module. The definition for class “SC” is shown in FIG. 8 in two different versions for exemplary purposes only; only one version would be deployed for the server-side application, depending on its requirements.

Class definition 804 is a first version of a class definition for class “SC” in which an ACL authorization method, “ACLClass:R”, is enforced at the class level by placing the enforcement construct of the present invention on the class definition. The object of the enforcement construct, “ACLClass:R”, provides an identifier for authorization method “R” within class “ACLClass”. Class definition 804 also contains method “M” and method “F”; therefore, a call to either method “M” or method “F” by a client application, e.g., by method “A”, requires successful completion of the ACL authorization method in order to successfully invoke either method “M” or method “F”.

Class definition 806 is a second version of a class definition for class “SC”. Class definition 806 also contains definitions for method “M” and method “F”. The definition of method “M” within class definition 806 includes the enforcement construct of the present invention for which an ACL authorization mechanism is enforced at the method level; therefore, a call to method “M”, e.g., by method “A”, requires successful completion of the ACL authorization method in order to successfully invoke method “M”. The definition of method “F” within definition 806 does not include the enforcement construct; therefore, a call to method “F”, e.g., by method “A”, does not perform the ACL authorization process.

An advantage of the present invention can be illustrated with respect to class definition 808. Because the present invention uses an object-oriented methodology, it inherently contains certain object-oriented features and receives their associated benefits, such as inheritance. For example, class definition 808 is a class definition for class “SCSC” that extends class “SC”, i.e., class “SCSC” is a subclass of class “SC”. Even though method “M” within subclass “SCSC” does not explicitly declare the use of the enforcement construct, method “M” (and all other methods in class “SCSC”) would have the ACL authorization method, “ACLClass:R”, enforced against it at the class level because the enforcement construct was associated with the superclass of class “SCSC”, namely class “SC”.

With reference now to FIGS. 9A-9C, identity information and a set of class descriptors within the runtime environment are shown in accordance with a preferred embodiment of the present invention. Similar reference numerals in FIGS. 9A-9C refer to similar elements; FIGS. 9A-9C continue the example for using the present invention from FIG. 8.

FIG. 9A shows identity table 902 that is stored within a data processing system in an appropriate manner for a particular runtime environment. If the data processing system is a distributed data processing system, such as the system shown in FIG. 3, then identity table 902 might be stored within authentication module 308 of server 304. More importantly, identity table 902 contains a list of identities that have been previously authenticated in some manner within the system. Each identity within the identity table may have other associated information, such as a session identifier, etc., as required by the runtime environment to associate state information with a client requester. Class descriptor 904 for class “CC” is used for a variety of purposes, such as dynamically looking up method “A” within the class descriptor when an attempt is made to call method “A”; the class descriptor may contain other information to be used by the runtime environment to perform the method invocation.

FIGS. 9B-9C show identity table 902 within the runtime environment and two different versions of a class descriptor for class “SC”. In the first version, FIG. 9B depicts class descriptor 906 that contains information for the methods that are defined within class “SC”; in the second version, FIG. 9C depicts class descriptor 908 that also contains information for the methods that are defined within class “SC”.

In a preferred embodiment of the present invention, the class descriptors contain the information necessary for performing an authorization process for an enforcement construct that is controlling access to a protected method. More specifically, the class descriptors contain information for invoking an authorization method prior to invoking the protected method. It should be noted that other data structures or runtime information may be used to determine that the called method was compiled with the inclusion of the enforcement construct for an authorization process.

For example, in the first version of the class descriptor, shown as class descriptor 906 in FIG. 9A, method descriptor 910 for method “M” and method descriptor 912 for method “F” show that method “R” of class “ACLClass” should be invoked prior to invoking either method “M” or method “F”. As described above with respect to FIG. 8, class definition 804, which corresponds to class descriptor 906, had an enforcement construct on the class definition, so the ACL authorization method is enforced against each method within class “SC”, as shown in class descriptor 906. When either method “M” or method “F” supported by class descriptor 906 is called, the identity of the requesting client is retrieved from identity table 902 and used as a parameter to method “R” of class “ACLClass”, which is invoked first. If the ACL authorization process returns a result that the identified client is permitted to invoke the protected method, then the protected method, either method “M” or method “F”, is invoked. It should be noted that other authorization information could be retrieved from the runtime environment and passed to the authorization method as required by the authorization method.

In the second version of the class descriptor, shown as class descriptor 908 in FIG. 9C, method descriptor 914 for method “M” and method descriptor 916 for method “F” show that method “R” of class “ACLClass” should be invoked prior to invoking only method “M” and not method “F”. As described above with respect to FIG. 8, class definition 806, which corresponds to class descriptor 908, had an enforcement construct only at the method level, so the ACL authorization method is only enforced against certain methods within class “SC”, as shown in class descriptor 908. When method “M” supported by class descriptor 908 is called, the identity of the requesting client is retrieved from identity table 902 and used as a parameter to method “R” of class “ACLClass”, which is invoked first. If the ACL authorization process returns a result that the identified client is permitted to invoke method “M”, then method “M” is invoked. When method “F” supported by class descriptor 908 is called, it is determined that method “F” is to be called without an access control restriction, and the appropriate preliminary processing is performed for the invocation of method “F”, such as reserving an appropriate amount of space on the call stack for the parameters of method “F”.

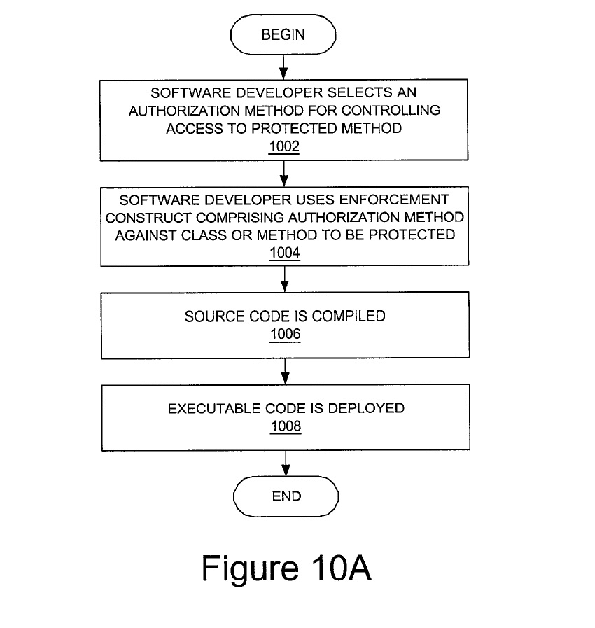

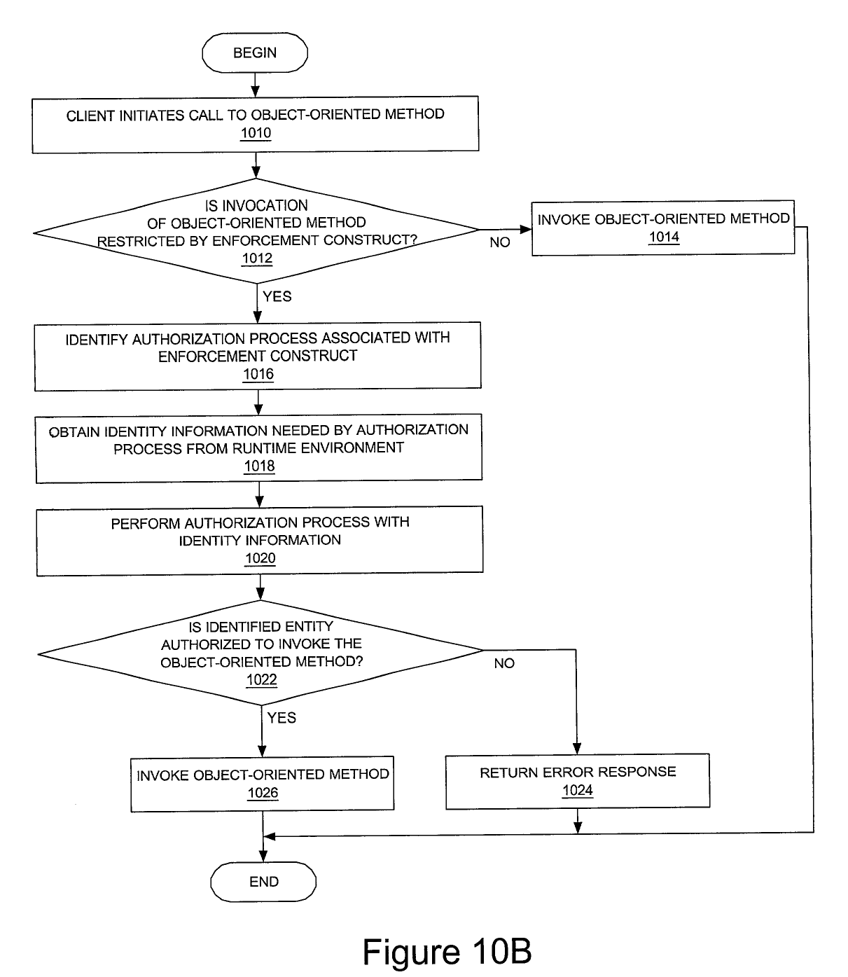

With reference now to FIG. 10A, a flowchart depicts a process for generating executable code that comprises the appropriate instructions for using the enforcement construct in accordance with a preferred embodiment of the present invention. The process begins when a programmer or software developer selects an authorization method to be used to control access to an object-oriented method (step 1002), i.e., a method that the programmer desires to configure as a protected method. The programmer places an enforcement construct against the method (or a class that defines the method) within a source code statement in accordance with the grammar or syntax of the special purpose object-oriented programming language that is being used to write a software module containing the protected method (step 1004). The source code is then compiled into executable code such that it contains the appropriate functionality to invoke the selected authorization method (step 1006). The executable code is deployed (step 1008), and the process is complete.

With reference now to FIG. 10B, a flowchart depicts a process for using the executable code that comprises the appropriate instructions for enabling the enforcement construct in accordance with a preferred embodiment of the present invention. The process begins when a client application or module initiates a call to an object-oriented method (step 1010). A determination is made as to whether all invocations of the object-oriented method have been protected by an object-oriented enforcement construct that has been configured to be associated with the object-oriented method (step 1012). If not, then the object-oriented method is invoked (step 1014), and the process is complete.

If an enforcement construct has been associated with the object-oriented method, then an authorization process associated with the enforcement construct is identified (step 1016). Any identity information for the calling entity that is needed by the authorization process is obtained from the runtime environment (step 1018), and the authorization process is performed using the obtained identity information (step 1020). It should be noted that the authorization process may be able to retrieve the identity information in an alternative manner.

A determination is made as to whether the identified calling entity is authorized to invoke the object-oriented method that has been protected by the enforcement construct (step 1022), as decided by the authorization process. If the calling entity is not authorized, then an error response may be returned to the calling entity (step 1024), and the process is complete. If the calling entity is authorized, then the protected method is invoked (step 1026), and the process is complete.

The advantages of the present invention should be apparent in view of the detailed description of the invention that is provided above. In prior art systems, controlling access to individual methods typically used an interception mechanism that intercepted calls to the protected method, and only authorized requesters were then permitted to complete the call to the protected method. In contrast, the present invention uses a special enforcement construct within an object-oriented programming language, thereby extending a common object-oriented language for a particular, special purpose. Therefore, the present invention inherently receives the advantages associated with using an object-oriented methodology for application development.

Although the use of the enforcement construct requires a compiler that recognizes the enforcement construct so that the appropriate enforcement code is generated, the present invention is able to reduce software development and maintenance costs. In the prior art, authorization for individual methods is performed by special purpose applications, which complicates the software development process and increases the complexity of maintaining system software. Any changes to an application that requires changes to the interceptor application must be administratively coordinated so that the changes can be designed, coded, and deployed at the same time. In the present invention, the enforcement mechanism is essentially built into the applications of the system that require an authorization mechanism. Any changes to an application that would otherwise require a change in the authorization mechanism can be completed and deployed simultaneously.

As noted above, a variety of authorization models, such as ACL-based models and RBAC-based models, could be supported by the present invention. Hence, the enforcement construct is not limited to operation with a specific type of authorization model.

It should be noted that because the enforcement construct of the present invention builds part of the authorization mechanism into the compiled code of an application, it is possible that a change in the authorization model might then require recompiling and redeploying client applications that otherwise did not require any other changes. In other words, the client application code must be changed solely to ensure that the client application code is compatible with the authorization model, whereas prior art systems might have limited code changes to the interceptor application and, in some cases, server-side modules. In systems in which the authorization model changes frequently, the present invention may be inferior to other authorization mechanisms.

However, it is expected that such scenarios would be uncommon. In most systems, administrative goals require that the authorization model itself be stable because of risks involved in a failed security system. Moreover, it may be assumed that many applications rely on a stable authorization system and that efforts are made to ensure that changes to the authorization model do not ripple into all of the applications that depend upon the authorization system. Assuming that the authorization model changes relatively infrequently, the present invention can significantly reduce development costs.

Another advantage of the present invention is that the enforcement construct of the present invention can be used in environments in which the interceptor methodology of the prior art cannot be used. For example, in the case of non-distributed local environments, there is no interprocess communication (IPC) call to be intercepted at the application level. Moreover, the enforcement construct of the present invention is a richer mechanism that is able to perform more robust authorization duties than other object-oriented restriction constructs, such as “private”, “protected”, “friendly”, and “public” that are available in some object-oriented languages.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A process for restricting access to an object-oriented method within a data processing system, the process comprising:
initiating a call to the object-oriented method from a requester;
determining whether an invocation of the object-oriented method has been restricted with an object-oriented enforcement construct;
in response to a determination that access to the object-oriented method has been restricted with an object-oriented enforcement construct, performing an authorization process to determine whether the requester is authorized to invoke the object-oriented method; and
in response to a determination that the requester is authorized to invoke the object-oriented method, invoking the object-oriented method.

2. The process of claim 1 further comprising:
in response to a determination that the requester is not authorized to invoke the object-oriented method, returning an error response to the requester for the call to the object-oriented method.

3. The process of claim 1 further comprising:
identifying the authorization process that is associated with the object-oriented method.

4. The process of claim 1 further comprising:
obtaining identity information associated with the requester; and
passing the identity information associated with the requester to the authorization process.

5. The process of claim 1 wherein the authorization process is performed by invoking an authorization method.

6. The process of claim 1 further comprising:
analyzing runtime environment information in order to determine whether an invocation of the object-oriented method has been restricted with an object-oriented enforcement construct.

7. The process of claim 1 wherein the invocation of the object-oriented method has been restricted with an object-oriented enforcement construct applied at a method level in a source code statement for the object-oriented method.

8. The process of claim 1 wherein the invocation of the object-oriented method has been restricted with an object-oriented enforcement construct applied at a class level in a source code statement for a class that includes the object-oriented method.

9. A process of generating source code for restricting access to an object-oriented method within a data processing system, the process comprising:
editing a source code statement that defines the object-oriented method within a source code file; and
modifying the source code file to include an enforcement construct, wherein the enforcement construct comprises an authorization process identifier associated with an authorization process and a reserved word to be recognized by a compiler as requiring runtime execution of the authorization process, prior to invoking the object-oriented method, to determine whether an entity is authorized to invoke the object-oriented method.

10. The process of claim 9 wherein the enforcement construct is included in the source code statement that defines the object-oriented method.

11. The process of claim 9 wherein the enforcement construct is included in a source code statement that defines a class that includes the object-oriented method.

12. A process of generating executable code for restricting access to an object-oriented method within a data processing system, the process comprising:
compiling source code that defines the object-oriented method within a source code file; and
compiling source code that defines an enforcement construct, wherein the enforcement construct comprises an authorization process identifier associated with an authorization process and a reserved word to be recognized by a compiler as requiring runtime execution of the authorization process, prior to invoking the object-oriented method, to determine whether an entity is authorized to invoke the object-oriented method.

13. The process of claim 12 wherein the enforcement construct is included in a source code statement that defines the object-oriented method.

14. The process of claim 12 wherein the enforcement construct is included in a source code statement that defines a class that includes the object-oriented method.

15. A process of restricting invocation of an object-oriented method within a data processing system, the process comprising:
identifying the object-oriented method within a data structure; and
associating an object-oriented enforcement construct with the object-oriented method, wherein the enforcement construct comprises an authorization process identifier associated with an authorization process that is to be executed, prior to invoking the object-oriented method, to determine whether an entity is authorized to invoke the object-oriented method.

16. A computer program product in a computer-readable medium for use within a data processing system for restricting access to an object-oriented method, the computer program product comprising:
instructions for initiating a call to the object-oriented method from a requester;
instructions for determining whether an invocation of the object-oriented method has been restricted with an object-oriented enforcement construct;
instructions for performing, in response to a determination that access to the object-oriented method has been restricted with an object-oriented enforcement construct, an authorization process to determine whether the requester is authorized to invoke the object-oriented method; and
instructions for invoking, in response to a determination that the requester is authorized to invoke the object-oriented method, the object-oriented method.

17. The computer program product of claim 16 further comprising:
instructions for returning, in response to a determination that the requester is not authorized to invoke the object-oriented method, an error response to the requester for the call to the object-oriented method.

18. The computer program product of claim 16 further comprising:
instructions for identifying the authorization process that is associated with the object-oriented method.

19. The computer program product of claim 16 further comprising:
instructions for obtaining identity information associated with the requester; and
instructions for passing the identity information associated with the requester to the authorization process.

20. The computer program product of claim 16 wherein the authorization process is performed by invoking an authorization method.

21. The computer program product of claim 16 further comprising:
instructions for analyzing runtime environment information in order to determine whether an invocation of the object-oriented method has been restricted with an object-oriented enforcement construct.

22. The computer program product of claim 16 wherein the invocation of the object-oriented method has been restricted with an object-oriented enforcement construct applied at a method level in a source code statement for the object-oriented method.

23. The computer program product of claim 16 wherein the invocation of the object-oriented method has been restricted with an object-oriented enforcement construct applied at a class level in a source code statement for a class that includes the object-oriented method.

24. A computer program product in a computer-readable medium for use within a data processing system to generate source code for restricting access to an object-oriented method, the computer program product comprising:
instructions for editing a source code statement that defines the object-oriented method within a source code file; and
instructions for modifying the source code file to include an enforcement construct, wherein the enforcement construct comprises an authorization process identifier associated with an authorization process and a reserved word to be recognized by a compiler as requiring runtime execution of the authorization process, prior to invoking the object-oriented method, to determine whether an entity is authorized to invoke the object-oriented method.

25. The computer program product of claim 24 wherein the enforcement construct is included in the source code statement that defines the object-oriented method.

26. The computer program product of claim 24 wherein the enforcement construct is included in a source code statement that defines a class that includes the object-oriented method.

27. A computer program product in a computer-readable medium for use within a data processing system to generate executable code for restricting access to an object-oriented method, the computer program product comprising:
instructions for compiling source code that defines the object-oriented method within a source code file; and
instructions for compiling source code that defines an enforcement construct, wherein the enforcement construct comprises an authorization process identifier associated with an authorization process and a reserved word to be recognized by a compiler as requiring runtime execution of the authorization process, prior to invoking the object-oriented method, to determine whether an entity is authorized to invoke the object-oriented method.

28. The computer program product of claim 27 wherein the enforcement construct is included in a source code statement that defines the object-oriented method.

29. The computer program product of claim 27 wherein the enforcement construct is included in a source code statement that defines a class that includes the object-oriented method.

30. A computer program product in a computer-readable medium for use within a data processing system for restricting invocation of an object-oriented method, the computer program product comprising:
instructions for identifying the object-oriented method within a data structure; and
instructions for associating an object-oriented enforcement construct with the object-oriented method, wherein the enforcement construct comprises an authorization process identifier associated with an authorization process that is to be executed, prior to invoking the object-oriented method, to determine whether an entity is authorized to invoke the object-oriented method.

31. An apparatus for restricting access to an object-oriented method within a data processing system, the apparatus comprising:
means for initiating a call to the object-oriented method from a requester;
means for determining whether an invocation of the object-oriented method has been restricted with an object-oriented enforcement construct;
means for performing, in response to a determination that access to the object-oriented method has been restricted with an object-oriented enforcement construct, an authorization process to determine whether the requester is authorized to invoke the object-oriented method; and
means for invoking, in response to a determination that the requester is authorized to invoke the object-oriented method, the object-oriented method.

32. The apparatus of claim 31 further comprising:
means for returning, in response to a determination that the requester is not authorized to invoke the object-oriented method, an error response to the requester for the call to the object-oriented method.

33. The apparatus of claim 31 further comprising:
means for identifying the authorization process that is associated with the object-oriented method.

34. The apparatus of claim 31 further comprising:
means for obtaining identity information associated with the requester; and
means for passing the identity information associated with the requester to the authorization process.

35. The apparatus of claim 31 wherein the authorization process is performed by invoking an authorization method.

36. The apparatus of claim 31 further comprising:
means for analyzing runtime environment information in order to determine whether an invocation of the object-oriented method has been restricted with an object-oriented enforcement construct.

37. The apparatus of claim 31 wherein the invocation of the object-oriented method has been restricted with an object-oriented enforcement construct applied at a method level in a source code statement for the object-oriented method.

38. The apparatus of claim 31 wherein the invocation of the object-oriented method has been restricted with an object-oriented enforcement construct applied at a class level in a source code statement for a class that includes the object-oriented method.
